(19) United States
(12) Patent Application Publication
(10) Pub. No.: US 2021/0324983 A1
(43) Pub. Date: Oct. 21, 2021

(54) COUPLING APPARATUS AND CORRUGATED HOSE ARRANGEMENT

(71) Applicant: DELFINGEN FR-Anteuil S.A., Anteuil (FR)

(72) Inventors: Tomasz KROLIK, München (DE); Carlo SCHOEPP, Schönberg (DE); Tobias THOMAMUELLER, Bruckmühl (DE)

(21) Appl. No.: 17/271,811

(22) PCT Filed: Aug. 13, 2019
(86) PCT No.: PCT/EP2019/071754

§ 371 Date: Feb. 26, 2021

(30) Foreign Application Priority Data
Aug. 31, 2018 (DE) 10 2018 121 293.3

(51) Int. Cl. F16L 25/00; F16L 37/098

(52) U.S. Cl. CPC F16L 25/0045; H02G 3/0468; F16L 37/0982

(57) ABSTRACT

A coupling apparatus for a corrugated hose has: a receiving part for receiving an end portion of the corrugated hose; a locking part mounted for rotation on the receiving part for locking the corrugated hose in the receiving part, the locking part having an engagement element that is elastically deformable for form-fit engagement in a corrugation of the corrugated hose, and the engagement element, with the aid of inserting the end portion into the receiving part, being elastically deformable to latch into the corrugation in a form-fitting manner; and a transmission device which converts a rotational movement of the locking part with respect to the receiving part into a radial movement of the engagement element away from the end portion in order to bring the engagement element out of form-fit engagement with the corrugation so that the end portion can be pulled out of the receiving part.

The present invention relates to a coupling device for a corrugated hose and to a corrugated hose arrangement having a coupling device of said type.

In order to connect hoses and pipes, for example corrugated hoses, to other components, such as for example plug connectors, hoses or the like, releasable quick-action couplings are known.

EP 0 983 462 B2 describes such a releasable quick-action coupling with a receiving housing into which a holding element can be inserted at a top side. By means of the holding element, a tubular insertion part can be coupled to the receiving housing.

EP 1 740 876 B1 describes a coupling for a fluid line system, having a coupling part and having a locking part releasably attached to the coupling part. A counterpart can be locked in the coupling part by means of the locking part.

Against this background, it is an object of the present invention to provide an improved coupling device.

Accordingly, a coupling device for a corrugated hose is proposed. The coupling device comprises a receiving part for receiving an end section of the corrugated hose, a locking part which is mounted rotatably on the receiving part and which serves for locking the corrugated hose in the receiving part, wherein the locking part has a resiliently elastically deformable engagement element for engaging in positively locking fashion into a corrugation of the corrugated hose, and wherein the engagement element is, by way of an insertion of the end section into the receiving part, resiliently elastically deformable so as to engage with positively locking detent action into the corrugation, and a mechanism device which converts a rotational movement of the locking part relative to the receiving part into a radial movement of the engagement element away from the end section in order to remove the engagement element from positively locking engagement with the corrugation, such that the end section can be pulled out of the receiving part.

By virtue of the fact that the rotational movement of the locking element relative to the receiving part can be converted into the radial movement of the engagement element away from the end section by means of the mechanism device, the corrugated hose can be released from the coupling device again conveniently and without the use of tools. The coupling device can thus be multiply reused.

The coupling device may also be referred to as a coupling, quick-action coupling or quick-action coupling device. The coupling device may also be suitable for being connected to some other suitable hose or pipe. The corrugated hose may also be referred to as corrugated pipe, or is a corrugated pipe. The corrugated hose comprises a multiplicity of mutually adjacently arranged corrugation troughs and corrugation peaks which form the corrugation extending along a longitudinal direction of the corrugated hose. Here, the engagement element engages into a corrugation trough between two corrugation peaks.

The receiving part is preferably a plastics component, in particular a plastics injection-molded component. The receiving part comprises a tubular or sleeve-like receiving section into which the end section of the corrugated hose can be inserted. The receiving part has not only the receiving section but also an attachment section which may have any desired geometry. The attachment section may be suitable for being connected to another corrugated hose, a smooth hose, a plug connector or any other desired component. Thus, by means of the coupling device, the corrugated hose can be connected to any other desired component. The corrugated hose may be part of a wiring harness. Multiple cables or lines may be received in the corrugated hose. Alternatively, the corrugated hose may itself also serve as a fluid line, for example as a washing water line or the like. A positively locking connection is formed as a result of the engagement of at least two connecting partners, in the present case the engagement element and the corrugation of the corrugated hose, into one another or behind one another.

The locking part preferably comprises a sleeve-like or tubular base section in which the receiving section of the receiving part is received. Here, the base section of the locking part is preferably slidingly mounted on the receiving section of the receiving part. The statement that the locking part is mounted “rotatably” on the receiving part is to be understood in particular to mean that the locking part can be rotated about the receiving part. The engagement element is preferably formed as a single piece, in particular materially integrally, with the locking part. The expression “as a single piece” is to be understood in particular to mean that the locking part and the engagement element form a common component. The expression “materially integrally” is to be understood in particular to mean that the locking part and the engagement element are manufactured from the same material throughout.

In particular, the end section of the corrugated hose can be inserted in a longitudinal direction of the coupling device into the receiving section of the receiving part. During the insertion of the end section into the receiving part, the engagement element slides on the corrugation and engages with detent action into a corrugation trough of the corrugation. In the present case, the expression “engage with detent action” is to be understood to mean that the engagement element elastically deforms during the insertion of the end section and of the receiving part and automatically snaps into a corrugation trough, such that the corrugated hose is connected in positively locking fashion to the coupling device by means of the engagement element.

The statement that the mechanism device “converts” the rotational movement into the radial movement is to be understood in the present case to mean that the mechanism device is suitable for transforming the rotational movement of the locking part relative to the receiving part into a translational movement of the engagement element. The radial movement may in this case the a purely linear movement of the engagement element away from the end section, and/or an at least partially arc-shaped movement of the engagement element.

In particular, the mechanism device is suitable for moving the coupling device from a locking state, in which the engagement element engages in positively locking fashion into the corrugation of the corrugated hose, into an unlocking state, in which the engagement element is not in positively locking engagement with the corrugation. The movement from the locking state into the unlocking state occurs by way of the rotational movement of the locking part relative to the receiving part. In particular, the engagement element is, by way of an attachment region, connected integral to the base section of the locking part. The engagement element pivots about said attachment region during the insertion of the end section of the corrugated hose into the receiving part and during the rotational movement of the locking part relative to the receiving part. The attachment region can thus act as a hinge. The attachment region may also be referred to as hinge region.

In one embodiment, the locking part is mounted on the receiving part rotatably about an axis of rotation, wherein the radial movement is oriented perpendicular to the axis of rotation and away from the latter.

The receiving part and the locking part may be of rotationally symmetrical design in relation to the axis of rotation. This means that the axis of rotation may be an axis of symmetry of the receiving part and/or of the locking part. As mentioned above, the locking part is slidingly mounted on the receiving part rotatably about the axis of rotation. The radial movement is preferably oriented perpendicular to the axis of rotation, though may also have an arc-shaped movement component which, as mentioned above, arises from the fact that the locking part is preferably connected in a hinged manner to the locking part by way of the attachment region and can be pivoted about said locking part.

According to a further embodiment, the engagement element has an engagement section for positively locking engagement into the corrugation and has a spring section which is resiliently elastically deformable.

In particular, the spring section is integral connected to the locking part by way of the attachment region. In particular, the engagement section and the spring section are of integral, in particular materially integral, form. Here, the engagement section forms a snap hook or detent hook which is provided at an end side on the spring section.

According to a further embodiment, the engagement section has a bevel which slides on the corrugation during the insertion of the end section into the receiving part.

In particular, the bevel slides on at least one corrugation peak of the corrugation during the insertion of the end section into the receiving part, whereby the spring section is resiliently elastically deformed and the engagement section is displaced outward in the radial direction. Here, the spring section preloads the engagement section in the direction of the corrugated hose. After the corrugation peak has been overcome, the engagement section then snaps into the following corrugation trough and connects the corrugated hose in positively locking fashion to the coupling device.

According to a further embodiment, the engagement section is curved in arc-shaped, in particular circular-arc-shaped, fashion.

Since the corrugated hose also has a circular or ring-shaped geometry in cross section, this results in particularly good engagement of the engagement section into the corrugation of the corrugated hose. An undesired release of the corrugated hose from the coupling device is hereby avoided.

According to a further embodiment, the locking part has a window which extends through the locking part and in which the engagement element is arranged.

Preferably, a multiplicity of such windows is provided, said windows being arranged so as to be distributed uniformly about a circumference of the locking part. For example, three such windows are provided. Accordingly, it is preferably also the case that three engagement elements are provided. However, at least one window is provided. The windows are rectangular, wherein the engagement element is connected integrally by way of the attachment region to a side edge of the window.

According to a further embodiment, the locking part has a multiplicity of engagement elements which are arranged so as to be distributed uniformly about a circumference of the locking part.

The number of engagement elements is arbitrary. For example, it is possible for one, two, three or even more engagement elements to be provided. The number of engagement elements preferably corresponds to the number of windows of the locking part, wherein each window is assigned an engagement element. It is preferable for three such engagement elements to be provided.

According to a further embodiment, the receiving part has a window which extends through the receiving part and through which the engagement element is led at least in certain sections.

The number of windows of the receiving part is arbitrary. In particular, the number of windows of the receiving part corresponds to the number of engagement elements. For example, three such windows are provided. The windows are preferably of rectangular form.

According to a further embodiment, the mechanism device has a contact surface provided on the receiving part and a counterpart contact surface provided on the engagement element, wherein, during the rotational movement of the locking part relative to the receiving part, the counterpart contact surface slides on the contact surface in order to convert the rotational movement into the radial movement of the engagement element away from the end section.

It is preferable for each of the abovementioned windows of the receiving part to comprise such a contact surface. The contact surface forms in particular a part of a cylinder, in particular of a circular cylinder. This means that the contact surface may be cylinder-shaped or cylinder-segment-shaped. The counterpart contact surface is in particular provided on the respective engagement section of the engagement element. Here, the counterpart contact surface is arranged perpendicular to the bevel of the engagement section. Accordingly, each engagement element can be assigned a mechanism device. Alternatively, it is also possible for all of the contact surfaces of the receiving part and all of the counterpart contact surfaces of the engagement elements to be part of one common mechanism device. During the rotational movement of the locking part relative to the receiving part, the counterpart contact surface slides on the contact surface assigned thereto, whereby the engagement section is moved outward in the radial direction. In this way, the spring section deforms in a resiliently elastic manner, and the respective engagement section is not in positively locking engagement with the corrugation, whereby the corrugated hose can be pulled out of the receiving part.

According to a further embodiment, the contact surface and/or the counterpart contact surface is curved in arc-shaped, in particular circular-arc-shaped, fashion.

The contact surfaces and the counterpart contact surfaces may in particular, as already mentioned, be part of a cylinder surface or have a cylinder-shaped geometry. Alternatively, the contact surface and the counterpart contact surface may also be formed as planes which are arranged obliquely.

According to a further embodiment, the rotational movement of the locking part relative to the receiving part has a first direction of rotation, wherein the engagement element subjects the locking part to a spring preload, counter to the rotational movement, in a second direction of rotation which is oriented oppositely to the first direction of rotation.

The first direction of rotation may for example be oriented clockwise or counterclockwise. As viewed in a viewing direction directed perpendicularly onto the receiving section of the receiving part and along the longitudinal direction of the coupling device, the first direction of rotation is preferably oriented counterclockwise. Accordingly, the second direction of rotation may be oriented clockwise. By virtue of the fact that the engagement element subjects the locking part to a spring preload, counter to the rotational movement, in the second direction of rotation, the engagement element, by way of the spring section, generates an opposing torque which acts oppositely to an actuating torque which is applied to the locking part for the purposes of actuating the coupling device. The opposing torque can thus move the coupling device automatically from the unlocking state into the locking state. This means that, as soon as a user no longer exerts the actuating torque on the locking part, the coupling device automatically moves from the unlocking state into the locking state.

According to a further embodiment, the rotational movement of the locking part relative to the receiving part is limited by means of an end stop.

It is preferable for a multiplicity of such end stops to be provided, which may be formed as protuberances extending out of the receiving section of the receiving part. The end stops are received in corresponding recesses of the locking element. The number of end stops is arbitrary. It is for example possible for three such end stops to be provided. The end stops are suitable for limiting the rotational movement of the locking part in both directions of rotation.

According to a further embodiment, the receiving part has a sealing element for sealing the end section with respect to the receiving part.

The sealing element is in particular tubular or sleeve-shaped. The sealing element is received in the receiving section of the receiving part. The sealing element is resiliently elastically deformed during the insertion of the end section of the corrugated hose into the receiving part. In particular, the sealing element imparts sealing in fluid-tight fashion with respect to a first corrugation peak received in the receiving part. In particular, the sealing element imparts sealing in the radial direction.

According to a further embodiment, the sealing element is cohesively connected to the receiving part, in particular is injection-molded onto the latter in a two-component injection molding process.

In cohesive connections, the connecting partners are held together by atomic or molecular forces. Cohesive connections are non-releasable connections which can be severed only by destruction of the connecting means and/or of the connecting partners. For example, the sealing element is manufactured from a thermoplastic elastomer, in particular from a thermoplastic polyurethane. By manufacturing in a two-component injection molding process, the receiving part can be produced quickly and inexpensively in large unit quantities. Retroactive mounting of the sealing element can be dispensed with. Furthermore, the sealing element is captively connected to the receiving part.

Also proposed is a corrugated hose arrangement having a corrugated hose and having a coupling device of the stated type, wherein an end section of the corrugated hose is received in the receiving part of the coupling device.

The corrugated hose arrangement may for example also comprise a smooth hose in addition to the corrugated hose, which smooth hose is connected to the attachment section of the receiving part. Furthermore, the corrugated hose arrangement may comprise cables and/or lines received in the corrugated hose. The corrugated hose arrangement may be part of a wiring harness.

Further possible implementations of the coupling device and/or of the corrugated hose arrangement also include combinations, which are not explicitly mentioned, of features or embodiments described above or below with regard to the exemplary embodiments. Here, a person skilled in the art will also add individual aspects as improvements or additions to the respective basic form of the coupling device and/or of the corrugated hose arrangement.

Further advantageous configurations and aspects of the coupling device and/or of the corrugated hose arrangement are the subject of the subclaims and of the exemplary embodiments, described below, of the coupling device and/or of the corrugated hose arrangement. The coupling device and/or the corrugated hose arrangement will be discussed in more detail below on the basis of preferred embodiments and with reference to the appended figures.

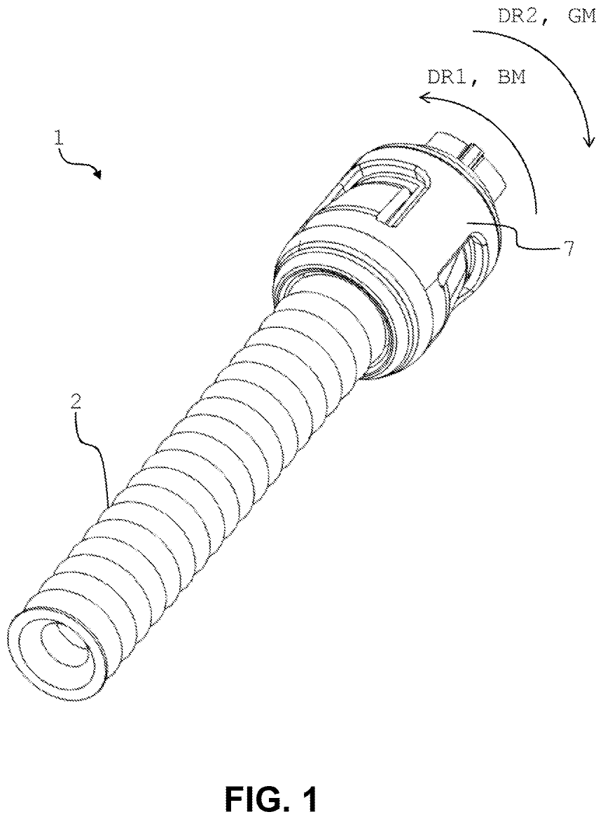

FIG. 1 shows a schematic perspective view of an embodiment of a corrugated hose arrangement;

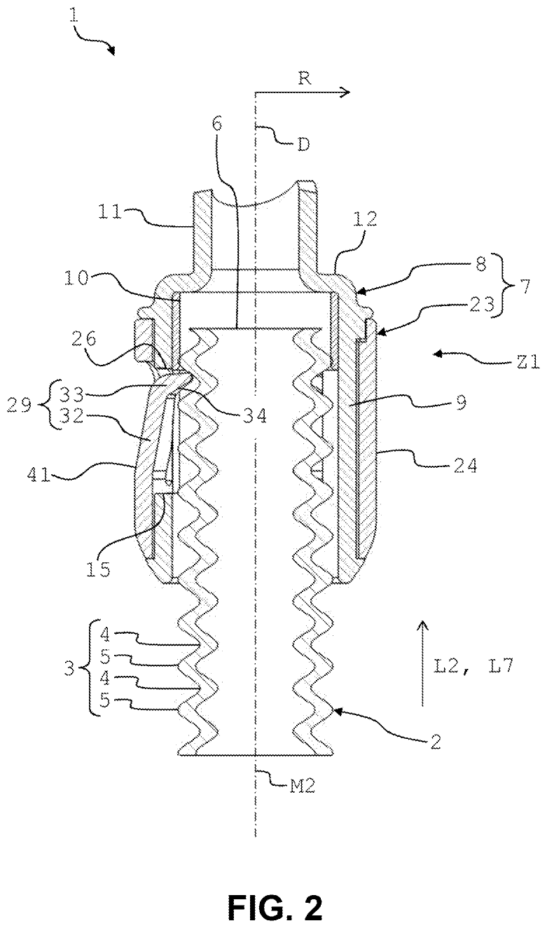

FIG. 2 shows a schematic sectional view of the corrugated hose arrangement as per FIG. 1;

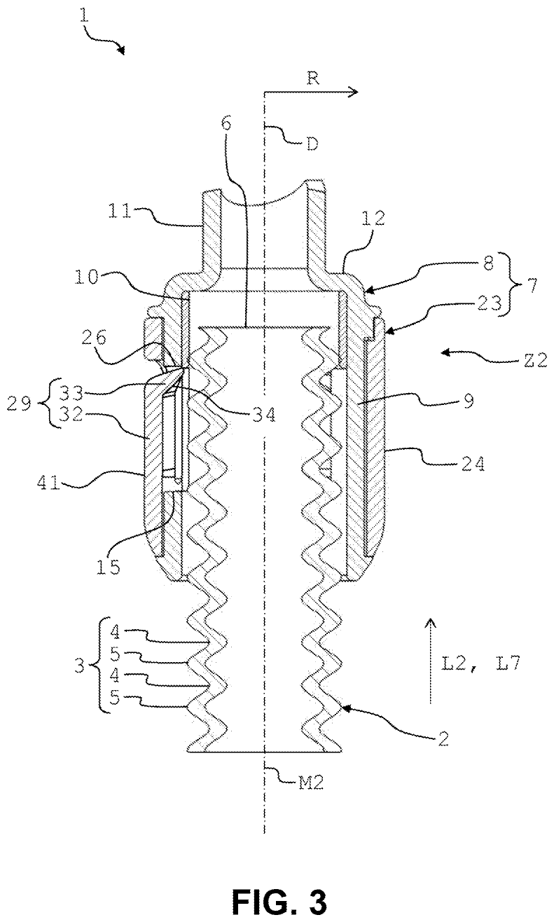

FIG. 3 shows a further schematic sectional view of the corrugated hose arrangement as per FIG. 1;

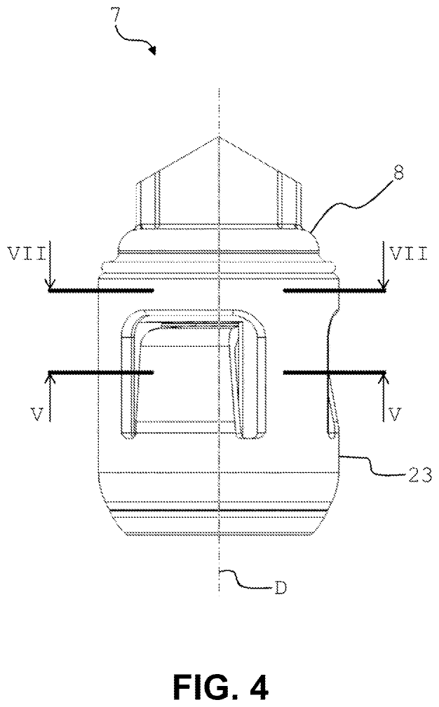

FIG. 4 shows a schematic side view of an embodiment of a coupling device for the corrugated hose arrangement as per FIG. 1;

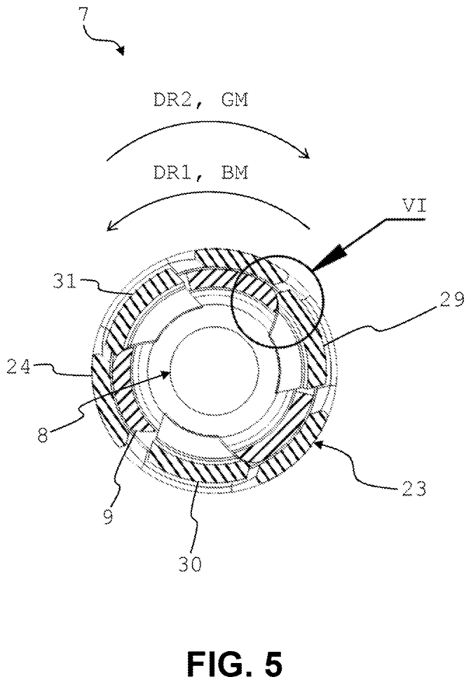

FIG. 5 shows a schematic sectional view of the coupling device according to the section line V-V of FIG. 4;

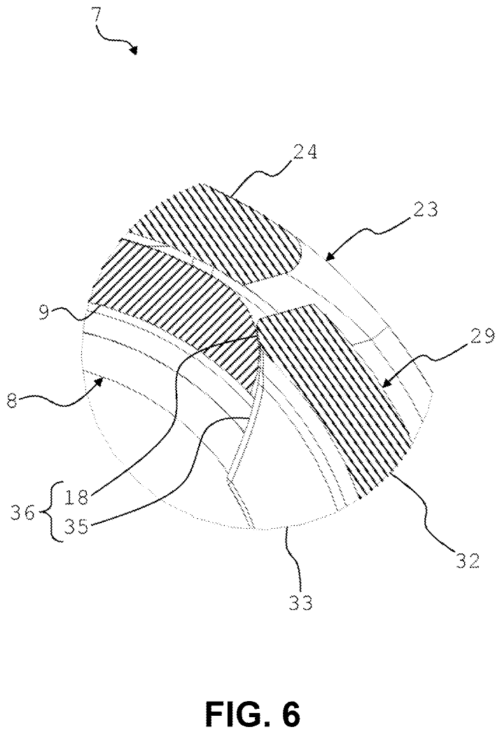

FIG. 6 shows the detail view VI as per FIG. 5;

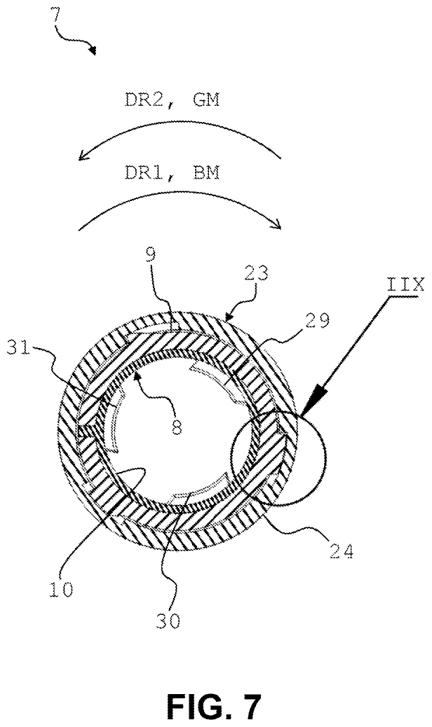

FIG. 7 shows a further schematic sectional view of the coupling device as per the section line VII-VII of FIG. 4;

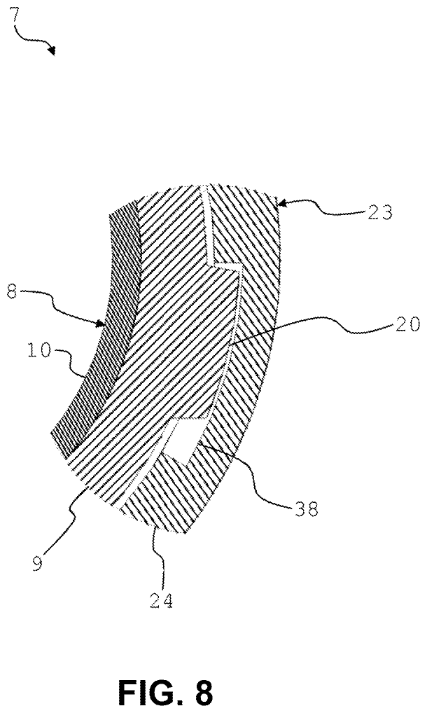

FIG. 8 shows the detail view VIII as per FIG. 7;

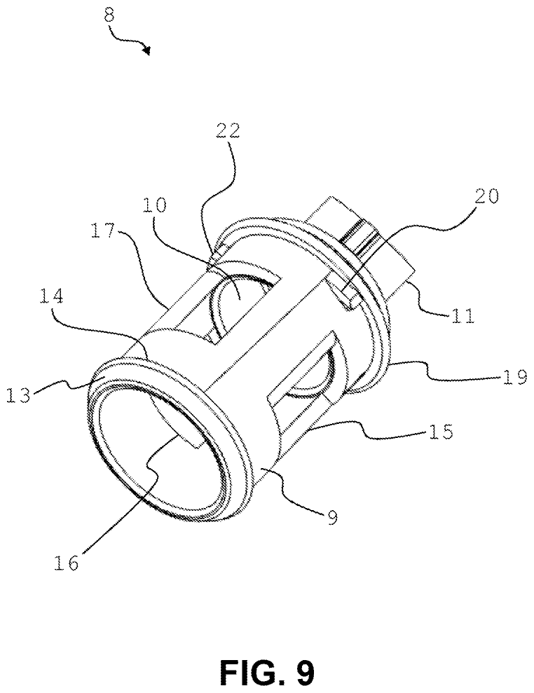

FIG. 9 shows a schematic perspective view of an embodiment of a receiving part for the coupling device as per FIG. 4;

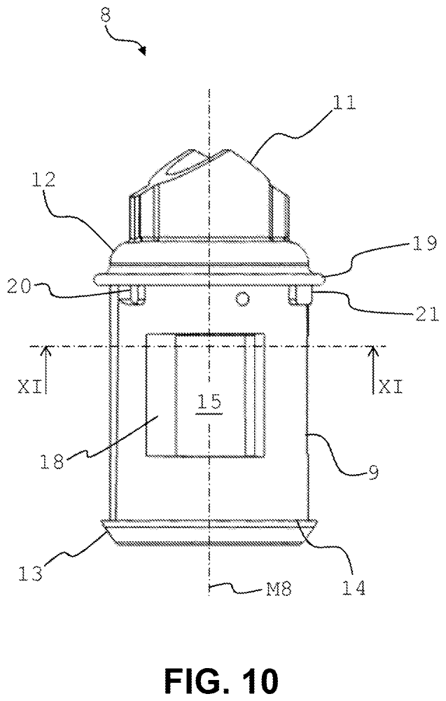

FIG. 10 shows a schematic side view of the receiving part as per FIG. 9;

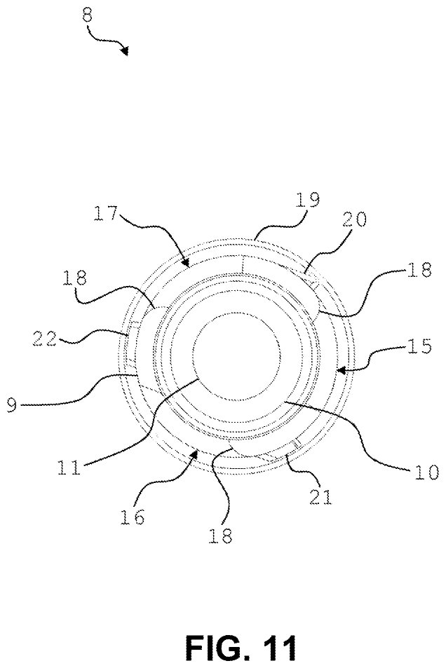

FIG. 11 shows a schematic sectional view of the receiving part as per the section line XI-XI of FIG. 10;

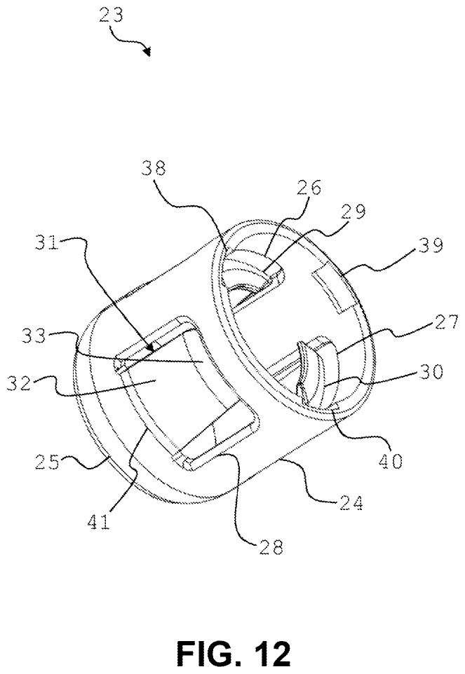

FIG. 12 shows a schematic perspective view of an embodiment of a locking part for the coupling device as per FIG. 4;

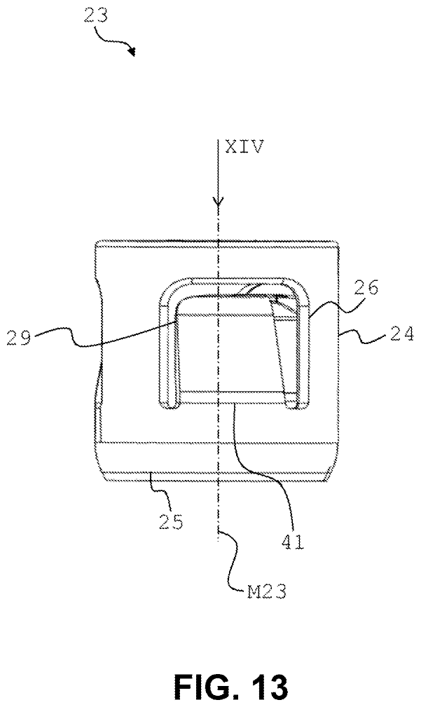

FIG. 13 shows a schematic side view of the locking part as per FIG. 12;

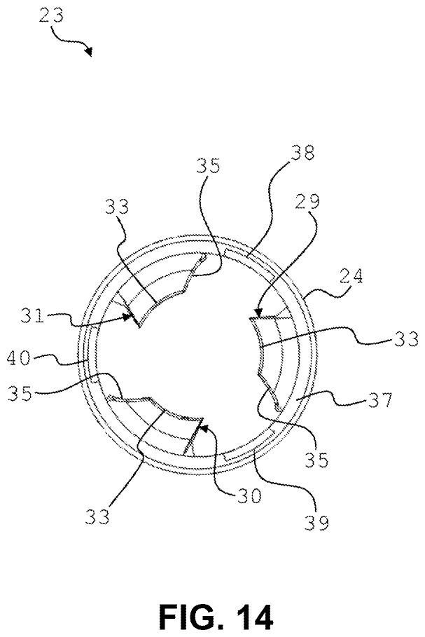

FIG. 14 shows a schematic view of the locking part as per the viewing direction XIV of FIG. 13; and

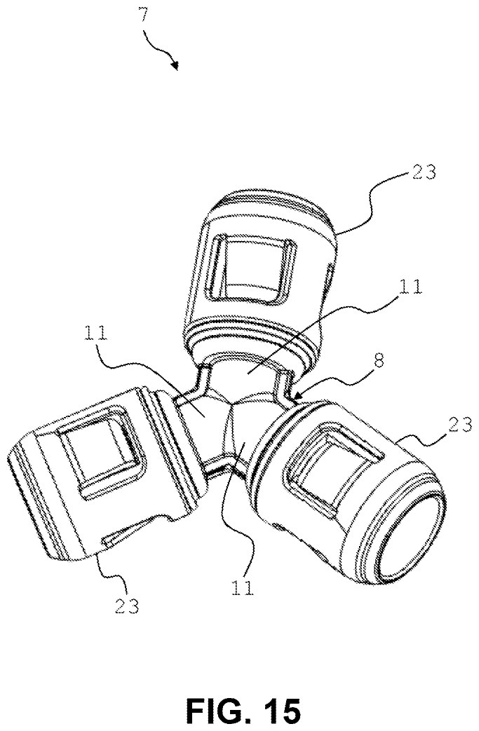

FIG. 15 shows a schematic perspective view of a further embodiment of a coupling device for the corrugated hose arrangement as per FIG. 1.

In the figures, identical or functionally identical elements have been denoted by the same reference designations unless stated otherwise.

FIG. 1 shows a schematic perspective view of an embodiment of a corrugated hose arrangement 1. FIGS. 2 and 3 each show schematic sectional views of the corrugated hose arrangement 1. FIGS. 1 to 3 will be discussed jointly below.

The corrugated hose arrangement 1 comprises a corrugated hose 2. The corrugated hose 2 is in particular suitable for forming a wiring harness. This means that the corrugated hose 2 or the corrugated hose arrangement 1 may be part of a wiring harness. For this purpose, a multiplicity of cables (not shown) may be accommodated in the corrugated hose 2. The cables may also be referred to as lines. The number of cables is arbitrary. The cables may have identical or different diameters and/or cross sections. To form the wiring harness, the cables are pushed or pulled into the corrugated hose 2. The corrugated hose 2 or the corrugated hose arrangement 1 is preferably used in the automotive engineering sector. The corrugated hose 2 or the corrugated hose arrangement 1 may however also be used in any other sector.

The cables may be electrical cables, for example single-phase cables, multi-phase cables, coaxial cables or the like, or fluid lines, such as for example gasoline, diesel, kerosene, hydraulic or pneumatic lines. The corrugated hose 2 is preferably manufactured from a plastics material. For example, the corrugated hose may be manufactured from polyamide (PA), polyethylene (PE), polypropylene (PP), polytetrafluoroethylene (PTFE), polyvinyl chloride (PVC) or the like. The corrugated hose 2 is preferably produced by way of an extrusion process. The corrugated hose 2 may also serve directly as a fluid line, for example as a washing water line or washing water hose. In this case, no lines are accommodated in the corrugated hose 2.

The corrugated hose 2 is of rotationally symmetrical construction about a central axis M2 or axis of symmetry M2. The corrugated hose 2 has a longitudinal direction L2 which is arranged parallel to the axis of symmetry M2 or which coincides therewith. The longitudinal direction L2 may, in the orientation of FIGS. 2 and 3, be oriented from bottom to top or vice versa. The corrugated hose 2 may also be referred to as a corrugated pipe.

The corrugated hose 2 comprises a corrugation 3. The corrugation 3 has a multiplicity of corrugation troughs 4 and corrugation peaks 5, which are arranged alternately as viewed in the longitudinal direction L2. This means that one corrugation peak 5 is arranged between two corrugation troughs 4, and vice versa. The number of corrugation troughs 4 and corrugation peaks 5 is arbitrary. In particular, the corrugated hose 2 is an endless product. In FIGS. 2 and 3, only in each case two corrugation troughs 4 and two corrugation peaks 5 are denoted by reference designations. The corrugated hose 2 furthermore comprises an end section 6 which is received in a coupling device 7 belonging to the corrugated hose arrangement 1.

The coupling device 7 is assigned an axis of rotation D. The axis of rotation D may in this case coincide with the axis of symmetry M2. Furthermore, the coupling device 7 is assigned a radial direction R. The radial direction R is positioned perpendicular to the axis of rotation D and points away from the latter. The coupling device 7 is furthermore assigned a longitudinal direction L7. The longitudinal direction L7 may coincide with the longitudinal direction L2. The coupling device 7 without the corrugated hose 2 is shown in FIGS. 4 to 8.

The coupling device 7 comprises a receiving part 8 which is shown in FIGS. 9 to 11 and which serves for receiving the end section 6 of the corrugated hose 2. FIGS. 9 to 11 will be referred to jointly below. The receiving part 8 is preferably a plastics component, in particular a plastics injection-molded component. For example, the receiving part 8 may be manufactured from PA, PE, PP or some other suitable plastics material. The receiving part 8 comprises a central axis M8 or axis of symmetry M8, about which the receiving part 8 may be of rotationally symmetrical construction.

The receiving part 8 comprises a sleeve-like or tubular receiving section 9 in which the end section 6 is received. A sleeve-like sealing element 10 is received in the receiving section 9. Here, the sealing element 10 is cohesively connected to the receiving section 9. In cohesive connections, the connecting partners are held together by atomic or molecular forces. Cohesive connections are non-releasable connections which can be severed only by destruction of the connecting means and/or of the connecting partners.

For example, the sealing element 10 is injection-molded onto the receiving section 9 in a plastics injection molding process. For example, the sealing element 10 is manufactured from a thermoplastic elastomer (TPE), for example from a thermoplastic polyurethane (TPU). The sealing element 10 is suitable for sealing off the end section 6 of the corrugated hose 2 in the radial direction R. This means that the corrugation 3, in particular at least one corrugation peak 5 of the corrugation 3, of the corrugated hose 2 lies against the inside of the sealing element 10, as shown in FIGS. 2 and 3.

The receiving part 8 furthermore comprises an attachment section 11. The attachment section 11 may be configured such that a hose, a plug connector or another corrugated hose can be attached thereto. The attachment section 11 may be of any desired configuration. For example, the attachment section 11 may be tubular. The attachment section 11 may for example have a smaller diameter than the receiving section 9. The receiving section 9 is closed off at an end side by a wall 12 from which the attachment section 11 extends.

The receiving part 8 has, at the bottom side in the orientation of FIGS. 9 and 10, an encircling bevel or chamfer 13. The chamfer 13 is adjoined by a shoulder 14 which runs in fully encircling fashion around the receiving section 9. The shoulder 14 preferably has a greater diameter than the receiving section 9. The tubular receiving section 9 is provided with a multiplicity of apertures or windows 15 to 17 (FIG. 9) which extend through the receiving section 9. The number of windows 15 to 17 is arbitrary.

For example, windows 15 to 17 of said type are provided which are arranged so as to be distributed uniformly about a circumference of the receiving section 9. In particular, a first window 15, a second window 16 and a third window 17 are provided. The windows 15 to 17 are in this case rectangular. Each window 15 to 17 comprises a contact surface 18 (FIG. 11). Each contact surface 18 is curved in arc-shaped, in particular circular-arc-shaped, fashion. This means that the respective contact surface 18 can have a cylinder-segment-shaped geometry. A “cylinder-segment-shaped geometry” is to be understood here to mean a surface which is curved in circular-arc-shaped fashion which is a segment of a cylinder, in particular a segment of a circular cylinder.

The receiving part 8 furthermore comprises a further shoulder 19 which runs in encircling fashion around the receiving section 9. The shoulder 19 has in particular a greater diameter than the receiving section 9. At the front side on the shoulder 19, that is to say facing toward the shoulder 14, the receiving part 8 comprises multiple end stops 20 to 22. The number of end stops 20 to 22 is arbitrary.

The coupling device 7 furthermore comprises a locking part 23 shown in FIGS. 12 to 14, which will be referred to jointly below. The locking part 23 is preferably a plastics component, in particular a plastics injection-molded component. For example, the locking part 23 may be manufactured from PA, PE, PP or some other suitable plastics material. The locking part 23 comprises a central axis M23 or axis of symmetry M23, about which the locking part 23 may be of rotationally symmetrical construction.

The locking part 23 is mounted on the receiving part 8 rotatably about the axis of rotation D. The locking part 23 comprises a sleeve-like or tubular base section 24. The receiving section 9 of the receiving part 8 is received in the base section 24. In particular, the base section 24 is arranged between the shoulders 14, 19 of the receiving part 8 (FIGS. 2 and 3). At the front side on the base section 24 in the orientation of FIGS. 12 and 13, there is provided a chamfer 25.

The locking part 23 comprises a multiplicity of apertures or windows 26 to 28 provided on the base section 24. The number of windows 26 to 28 is arbitrary. It is preferable for three such windows 26 to 28 to be provided, which are arranged so as to be distributed uniformly about a circumference of the locking part 23. In particular, a first window 26, a second window 27 and a third window 28 are provided. The number of windows 26 to 28 of the locking part 23 preferably corresponds to the number of windows 15 to 17 of the receiving part 8, wherein each window 15 to 17 of the receiving part 8 may be assigned a corresponding window 26 to 28 of the locking part 23. The windows 26 to 28 of the locking part 23 are in this case of rectangular form.

Each window 26 to 28 is assigned a resiliently elastically deformable engagement element 29 to 31. The engagement elements 29 to 31 are positioned within the windows 26 to 28. Here, the engagement elements 29 to 31 are formed materially integrally with the base section 24. In particular, a first engagement element 29, a second engagement element 30 and a third engagement element 31 are provided. Each engagement element 29 to 31 comprises a resiliently elastically deformable spring section 32 and an engagement section 33, arranged at an end side on the spring section 32, for positively locking engagement into the corrugation 3 of the corrugated hose 2. A positively locking connection arises as a result of the engagement of at least two connecting partners, in the present case the engagement section 33 and the corrugation 3, into one another or behind one another.

As shown in FIG. 14, the engagement sections 33 may be curved in circular-arc-shaped fashion. The engagement sections 33 furthermore each comprise a chamfer 34 (FIGS. 2 and 3), which is configured to slide on the corrugation 3. Furthermore, on each engagement element 29 to 31 and in particular on each engagement section 33 of the respective engagement element 29 to 31, there is provided a counterpart contact surface 35 which is designed correspondingly to the contact surfaces 18 of the windows 15 to 17. The counterpart contact surfaces 35 are curved in arc-shaped, in particular circular-arc-shaped, fashion.

The contact surfaces 18 of the windows 15 to 17 and the counterpart contact surfaces 35 of the engagement elements 29 to 31 in each case jointly form a mechanism device 36 (FIG. 6). In particular, it is thus the case that three such mechanism devices 36 are provided. It is also possible for all of the contact surfaces 18 and all of the counterpart contact surfaces 35 to form one common mechanism device 36. Multiple recesses 38 to 40 for receiving the end stops 20 to 22 are provided on an end surface 37 (FIG. 14) of the base section 24.

The functionality of the coupling device 7 will be discussed below on the basis of FIGS. 1 to 8. For the locking of the corrugated hose 2 to the coupling device 7, said corrugated hose is pushed with the end section 6 into the receiving section 9 of the receiving part 8 in the longitudinal direction L7. Here, the chamfer 34 of the engagement sections 33 of the engagement elements 29 to 31 comes into contact with the corrugation 3 of the corrugated hose 2. In other words, the respective chamfer 34 slides on the corrugation peaks 5, whereby the respective spring section 32 of the engagement elements 29 to 31 is resiliently elastically deformed and the engagement sections 33 perform an outward radial movement in the radial direction R. This means that the engagement sections 33 of the engagement elements 29 to 31 are moved outward away from the corrugated hose 2 in the radial direction R.

Here, the radial movement may be a linear movement in the radial direction R or else may be an arc-shaped movement. The radial movement may also be a combination of a linear movement and an arc-shaped movement. The engagement elements 29 to 31 may, during this radial movement, pivot about an attachment region 41 (FIGS. 2 and 3) by way of which the respective engagement elements 29 to 31 are connected to the base section 24. As soon as the chamfer 34 slides over a corrugation peak 5, the respective engagement section 33 engages with detent action into the following corrugation trough 4, such that the engagement elements 29 to 31 connect the corrugated hose in positively locking fashion to the coupling device 7.

The corrugated hose 2 can then be pushed into the receiving section 9 to such an extent that the corrugated hose lies against the inside of the wall 12. The corrugated hose 2 is however preferably pushed into the receiving section 9 only to such an extent that a first corrugation peak 5 of the end section 6 is in contact with the sealing element 10. Here, the sealing element 10 seals the corrugated hose 2 in a radially outward direction as viewed in the radial direction R. In particular, here, the sealing element 10 lies against at least the first corrugation peak 5 of the corrugation 3.

As soon as the engagement sections 29 to 31 have engaged with detent action into the corrugation 3, the coupling device 7 is in a locking state Z1 shown in FIG. 2, in which the engagement elements 29 to 31 are in positively locking engagement with the corrugation 3 of the corrugated hose 2.

In order to now move the coupling device 7 from the locking state Z1 shown in FIG. 2 into an unlocking state Z2 shown in FIG. 3, in which the engagement elements 29 to 31 are not in positively locking engagement with the corrugation 3 of the corrugated hose 2, an actuating torque BM which acts in a first direction of rotation DR1 (FIGS. 1, 5 and 7) is applied to the locking part 23, such that the locking part 23 performs a rotational movement relative to the receiving part 8 about the axis of rotation D. The first direction of rotation DR1 may in this case be oriented counterclockwise or in the opposite direction.

Here, the mechanism device 36, which comprises the respective contact surface 18 of the windows 15 to 17 and the counterpart contact surface 35 of the engagement elements 29 to 31, converts the rotational movement of the locking part 23 relative to the receiving part 8 into a radial movement of the engagement elements 29 to 31, in particular of the engagement sections 33, such that these are moved outward in the radial direction R away from the corrugated hose 2. As a result, the engagement sections 33 of the engagement elements 29 to 31 move out of positively locking engagement with the corrugation 3, such that the corrugated hose 2 can be pulled out of the receiving section 9 again counter to the longitudinal direction L7.

As a result of the rotational movement, the spring sections 32 of the engagement elements 29 to 31 are resiliently elastically deformed. The spring sections 32 of the engagement elements 29 to 31 however preload the coupling device 7 with an opposing torque GM, which acts counter to the actuating torque BM, in the direction of the locking state Z1, such that the coupling device 7 automatically moves back into the locking state Z1 after a release of the locking part 23.

The engagement elements 29 to 31 thus preload the locking part 23, counter to the rotational movement, in a second direction of rotation DR2 which is oriented oppositely to the first direction of rotation DR1. The opposing torque GM acts in the second direction of rotation DR2. As shown in FIG. 8, the end stops 20 to 22 limit the rotational movement of the locking part 23 relative to the receiving part 8 in both directions of rotation DR1, DR2.

By means of the coupling device 7, automatic or manual mounting of the corrugated hose 2 is possible without release of the arresting action. The sealing of the corrugated hose 2 can be realized already at the first corrugation peak 5 of the end section 6. Dismounting of the coupling device 7 is possible without the use of tools. After the actuating torque BM is no longer applied to the locking part 23, the latter automatically moves back into the locking state Z1. The coupling device 7 can be reused as often as desired.

FIG. 15 shows a schematic perspective view of a further embodiment of a coupling device 7. In this embodiment of the coupling device 7, the latter comprises a receiving part 8 with multiple, for example with three, receiving sections 9, which are connected to one another by way of their attachment sections 11. The result is thus a Y-shaped geometry of the coupling device 7. The coupling device 7 may however have any other desired geometry. Correspondingly, the coupling device 7 also comprises multiple, for example three, locking parts 23. By means of the coupling device 7, it is thus possible, for example, for three corrugated hoses 2 to be connected to one another.

Although the present invention has been described on the basis of exemplary embodiments, it is modifiable in a wide variety of ways.

### LIST OF REFERENCE CHARACTERS

1 Corrugated hose arrangement
2 Corrugated hose
3 Corrugation
4 Corrugation trough
5 Corrugation peak
6 End section
7 Coupling device
8 Receiving part
9 Receiving section
10 Sealing element
11 Attachment section
12 Wall
13 Chamfer
14 Shoulder
15 Window
16 Window
17 Window
18 Contact surface
19 Shoulder
20 End stop
21 End stop
22 End stop
23 Locking part
24 Base section
25 Chamfer
26 Window
27 Window
28 Window
29 Engagement element
30 Engagement element
31 Engagement element
32 Spring section
33 Engagement section
34 Bevel
35 Counterpart contact surface
36 Mechanism device
37 End surface
38 Recess
39 Recess
40 Recess
41 Attachment region
BM Actuating torque
D Axis of rotation
DR1 Direction of rotation
DR2 Direction of rotation
GM Opposing torque
L2 Longitudinal direction
L7 Longitudinal direction
M2 Axis of symmetry
M8 Axis of symmetry
M23 Axis of symmetry
R Radial direction
Z1 Locking state
Z2 Unlocking state

1. A coupling device for a corrugated hose, having:
a receiving part for receiving an end section of the corrugated hose,
a locking part which is mounted rotatably on the receiving part and which serves for locking the corrugated hose in the receiving part, wherein the locking part has a resiliently elastically deformable engagement element for engaging in positively locking fashion into a corrugation of the corrugated hose, and wherein the engagement element is, by way of an insertion of the end section into the receiving part, resiliently elastically deformable so as to engage with positively locking detent action into the corrugation, and
a mechanism device which converts a rotational movement of the locking part relative to the receiving part into a radial movement of the engagement element away from the end section in order to remove the engagement element from positively locking engagement with the corrugation, such that the end section can be pulled out of the receiving part.

2. The coupling device as claimed in claim 1, wherein the locking part is mounted on the receiving part rotatably about an axis of rotation, and wherein the radial movement is oriented perpendicular to the axis of rotation and away from the latter.

3. The coupling device as claimed in claim 1, wherein the engagement element has an engagement section for positively locking engagement into the corrugation and has a spring section which is resiliently elastically deformable.

4. The coupling device as claimed in claim 3, wherein the engagement section has a bevel which slides on the corrugation during the insertion of the end section into the receiving part.

5. The coupling device as claimed in claim 3, wherein the engagement section is curved in arc-shaped, in particular circular-arc-shaped, fashion.

6. The coupling device as claimed in claim 1, wherein the locking part has a window which extends through the locking part and in which the engagement element is arranged.

7. The coupling device as claimed in claim 1, wherein the locking part has a multiplicity of engagement elements which are arranged so as to be distributed uniformly about a circumference of the locking part.

8. The coupling device as claimed in claim 1, wherein the receiving part has a window which extends through the receiving part and through which the engagement element is led at least in certain sections.

9. The coupling device as claimed in claim 1, wherein the mechanism device has a contact surface provided on the receiving part and a counterpart contact surface provided on the engagement element, and wherein, during the rotational movement of the locking part relative to the receiving part, the counterpart contact surface slides on the contact surface in order to convert the rotational movement into the radial movement of the engagement element away from the end section.

10. The coupling device as claimed in claim 9, wherein the contact surface and/or the counterpart contact surface is curved in arc-shaped, in particular circular-arc-shaped, fashion.

11. The coupling device as claimed in claim 1, wherein the rotational movement of the locking part relative to the receiving part has a first direction of rotation, and wherein the engagement element subjects the locking part to a spring preload, counter to the rotational movement, in a second direction of rotation which is oriented oppositely to the first direction of rotation.

12. The coupling device as claimed in claim 1, wherein the rotational movement of the locking part relative to the receiving part is limited by means of an end stop.

13. The coupling device as claimed in claim 1, wherein the receiving part has a sealing element for sealing the end section with respect to the receiving part.

14. The coupling device as claimed in claim 13, wherein the sealing element is cohesively connected to the receiving part, in particular is injection-molded onto the latter in a two-component injection molding process.

15. A corrugated hose arrangement having a corrugated hose and having a coupling device as claimed in claim 1, wherein an end section of the corrugated hose is received in the receiving part of the coupling device.
